(19) United States
(12) Patent Application Publication
(10) Pub. No.: US 2016/0241440 A1
(43) Pub. Date: Aug. 18, 2016

(54) PROVIDING NETWORK MANAGEMENT INFORMATION IN A COMMUNICATIONS NETWORK

(71) Applicant: Telefonaktiebolaget L M Ericsson (publ), Stockholm (SE)

(72) Inventor: Jaime JIMÉNEZ, Helsinki (FI)

(21) Appl. No.: 15/024,808

(22) PCT Filed: Sep. 27, 2013
(86) PCT No.: PCT/EP2013/070273

§ 371 Date: Mar. 24, 2016

(51) Int. Cl. H04L 12/24

(52) U.S. Cl. CPC H04L 41/0816; H04L 41/12

(57) ABSTRACT

A method and apparatus for providing network management information to a manager node in a distributed communication network. An agent node in the distributed communication network receives a Distributed Hash Table overlay stabilization procedure message. The overlay stabilization procedure message includes an instruction for the agent node to send network management information to the manager node. The agent node then sends network management information to the manager node.

### TECHNICAL FIELD

The invention relates to the field of providing network management information in a communications network.

### BACKGROUND

The Simple Network Management Protocol (SNMP) is an Internet protocol for network management. It is typically used by network administrators to monitor and map network performance, availability and errors.

An SNMP network managed device implements an SNMP interface and has a software agent that runs on the managed device. Examples of managed devices include network elements such as router, servers, hubs and so on. SNMP allows node specific information to be provided to a Network Management System (NMS). The agent obtains information about local conditions at the node, and translates this into a form that the NMS can interpret.

While SNMP is often used in a client/server type of network, it can also be adapted for use in a distributed network in conjunction with Distributed Hash Tables (DHT). A DHT provides a lookup service using key/value pairs, and allows any node to retrieve a value associated with a particular key. Information is associated with a particular key, and the node storing that information can be identified by hashing the key. A requesting node that requires information from the node can therefore look up the key associated with the information and hash the key in order to obtain the identity of the storing node.

For SNMP in a distributed network, a DHT can be used to identify agents that are managed by a particular manager.

### SUMMARY

DHTs in a distributed network operate stabilization procedures to ensure that the routing information is consistent throughout the overlay. These stabilization procedures are usually performed periodically and at regular intervals. A stabilization procedure may also be triggered depending on the churn of the overlay. For example, a peer node in a distributed network may update its routing table when a neighbor ungracefully leaves the overlay. This ensures that, as network circumstances and conditions change, the DHT is updated.

If the overlay is of large size, periodic stabilization has less risk of creating congestion and uses less bandwidth, as described in Rhea, S., Geels, D., Roscoe, T., and J. Kubiatowicz, “Handling churn in a DHT”, In Proc. of the USENIX Annual Technical Conference June 2004. For this reason most existing DHTs incorporate periodic stabilization procedures in the logic of the overlay.

As described above, SNMP defines a manager and an agent. The manager usually sends messages towards the agents and sends instructions determining when the agent has to send Trap messages, or instructing the agent to report Errors when they occur. Among the messages sent the ‘Get bulk’ message (see RFC 1905 SNMPv2, section 4.2.3) operation is the most demanding and time consuming.

The purpose of the GetBulkRequest-Protocol Data Unit (PDU) is to request the transfer of a potentially large amount of data, for example a large amount of entries in the Management Information Base (MIB) on the agent. This is done in order to minimize the number of messages sent when retrieving a lot of information. Referring to FIG. 1, a manager 1 sends a GetBulkRequest message to an agent 2. The GetBulkRequest message instructs the agent 2 to send as much data to the manager 1 as the PDU can carry. The Bulk-Request command defines two variables: non-repeaters and max-repetitions.

Machine to machine (M2M) networks allow network nodes to exchange information without human intervention, and are typically distributed. In the M2M scenario, the peers of the DHT act as agents, managers or both simultaneously. However SNMP has not been fully adapted to this scenario. A significant problem is to store the MIB in the peers themselves. When a manager requires a lot of data from the MIB, in the agents or from the DHT itself, it has to query each individual peer one by one or it has to retrieve some resource in the DHT where this data is stored. This can lead to a significant amount of signaling. It is an object to reduce the amount of signalling required in this situation. It is also an object to more efficiently manage SNMP signalling in a distributed network.

According to a first aspect, there is provided a method of providing network management information to a manager node in a distributed communication network. An agent node in the distributed communication network receives a Distributed Hash Table (DHT) overlay stabilization procedure message. The overlay stabilization procedure message includes an instruction for the agent node to send network management information to the manager node. The agent node then sends network management information to the manager node. An advantage of this is that requests for network management information can be piggybacked onto overlay stabilization messages which in any case are sent to all nodes in the distributed communication network, thereby greatly reducing the required amount of signalling.

Different protocols for sending network management information may be used. The method optionally uses Simple Network Management Protocol (SNMP) or Open Mobile Alliance Device Management (OMADM) protocol.

As an option, the instruction may be a get bulk request message, a get request message or a set request message.

The overlay stabilization procedure message is optionally sent periodically, or sent in the event that an update is required owing to a change in network conditions.

As an option, the instruction further includes any of an indication that the manager node is authorized as a manager node, an identity of at least one node from which network management information is required, and adjustments to any of non-repeater and maximum repetition fields. By providing the identities of nodes from which network management information is required, only those nodes need reply to the manager, further reducing the amount of signalling necessary.

The method optionally includes determining if network management information has previously been sent to the manager node. If so, a determination is made as to whether any changes to the management information have occurred. If so, the agent sends the network management information to the manager node. This avoids unnecessary signalling in the event that no changes have been made to the required network management information.

As an option, the method includes determining if network management information has been requested from the agent node and, if so, sending the network management information to the manager node.

According to a second aspect, there is provided an agent node for use in a distributed communication network. The agent node is provided with a network management protocol agent and a receiver for receiving a DHT overlay stabilization procedure message. The overlay stabilization procedure message includes an instruction for the agent node to send network management information to a manager node. A processor is provided for generating a response message, the response message including the required network management information. A transmitter is also provided for sending the response message to the manager node.

The processor is optionally arranged to determine the presence, in the DHT overlay stabilization procedure message, of any of an indication that the manager node is authorized as a manager node, an identity of at least one node from which network management information is required, and adjustments to any of non-repeater and maximum repetition fields.

As an option, the processor is arranged to determine if network management information has previously been sent to the manager node and, if so, determine if any changes to the management information have occurred.

The processor is optionally arranged to determine if network management information has been requested from the agent node.

According to a third aspect there is provided a manager node for use in a distributed communication network. The manager node is provided with a network management manager. A transmitter is provided for sending towards an agent node a DHT overlay stabilization procedure message. The overlay stabilization procedure message including an instruction for the agent node to send network management information to a manager node. A receiver is provided for receiving network management information from the agent node.

According to a fourth aspect there is provided a computer program comprising computer readable code means which, when run on an agent node in a distributed communication network, causes the agent node to perform the method described above in the first aspect.

According to a fifth aspect there is provided a computer program comprising computer readable code means which, when run on a manager node in a distributed communication network, causes the manager node perform the steps of sending towards an agent node a DHT overlay stabilization procedure message. The overlay stabilization procedure message includes an instruction for the agent node to send network management information to a manager node. The manager node then receives network management information from the agent node.

According to a sixth aspect there is provided a computer program product comprising a computer readable medium and a computer program as described in either of the fourth or fifth aspects, wherein the computer program is stored on the computer readable medium.

### BRIEF DESCRIPTION OF THE DRAWINGS

FIG. 1 illustrates schematically in a block diagram a GetBulkRequest message and response between a manager and an agent in an SNMP enabled network;

FIG. 2 illustrates schematically in a block diagram exemplary GetBulkRequest messages and responses between a manager and a plurality of agents in a distributed SNMP enabled network;

FIG. 3 is a flow diagram showing exemplary steps;

FIG. 4 illustrates schematically in a block diagram an exemplary GetBulkRequest message sent using DHT stabilization procedures, and responses towards a manager from a plurality of agents in a distributed SNMP enabled network;

FIG. 5 illustrates schematically in a block diagram an exemplary agent node; and

FIG. 6 illustrates schematically in a block diagram an exemplary manager node.

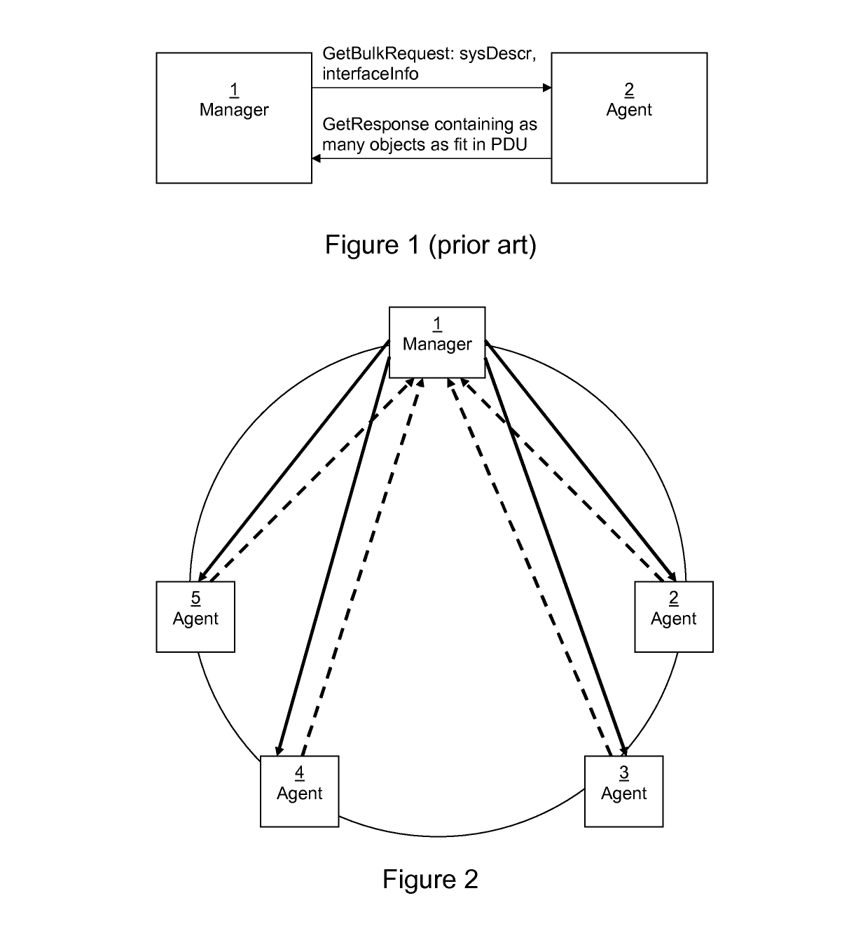

### DETAILED DESCRIPTION

There is described herein a way of providing network management information to a manager node in a distributed communication network. While the following description refers to the network management information being provided using Simple Network Management Protocol (SNMP), it will be appreciated that other network management protocols may be used. Examples of other network management protocols include Open Mobile Alliance Device Management (OMADM) and OMADM Lightweight.

Referring to FIG. 2, consider a scenario in which a manager node 1 must collect some information from a plurality of agent nodes 2, 3, 4, 5 in a distributed communication network. Assuming that manager node 1 requires network management information such as device status, system uptime and network utilization for multiple interfaces and on multiple agents 2, 3, 4, 5. Using normal network management procedures, such as those provided by SNMP, the manager node 1 sends a getbulkRequest towards every agent 2, 3, 4, 5. In FIG. 2, the solid lines represent each getbulkRequest message sent from the manager node 1, and the dashed lines represent each response from the agent nodes 2, 3, 4, 5. The SNMP signalling is performed as thought the network is a regular client/server network, as regular SNMP is not designed for distributed networks. In this case it is necessary to send at least one message per agent node. While this does not appear to be problematic in the example of FIG. 2, it would become very resource intensive in a very large and complicated distributed network.

For example, if each agent 2, 3, 4, 5 has four interfaces, for every agent the manager node 1 would need to send an individual message as follows:

Request-GetBulk

non-repeaters=1

max-repetitions=4

sysUpTime.0

ifInOctets

Each agent node 2, 3, 4, 5 replies with its uptime, its status (if connected) and some parameter defining whether the interface is in use or not to the manager node 1 and the manager node 1 will receive the information and process it. This is extremely inefficient and resource intensive in a large distributed network.

It has been realized that network management signalling can be sent much more efficiently by piggybacking the signalling on a Distributed Hash Table (DHT) overlay stabilization message. Such a message is sent to all nodes in the distributed network, and so the manager node 1 would only need to send a message such as a getbulkRequest message to one node. The message would then be propagated throughout the distributed network and any relevant agent nodes 2,3,4,5 could respond to the manager node 1.

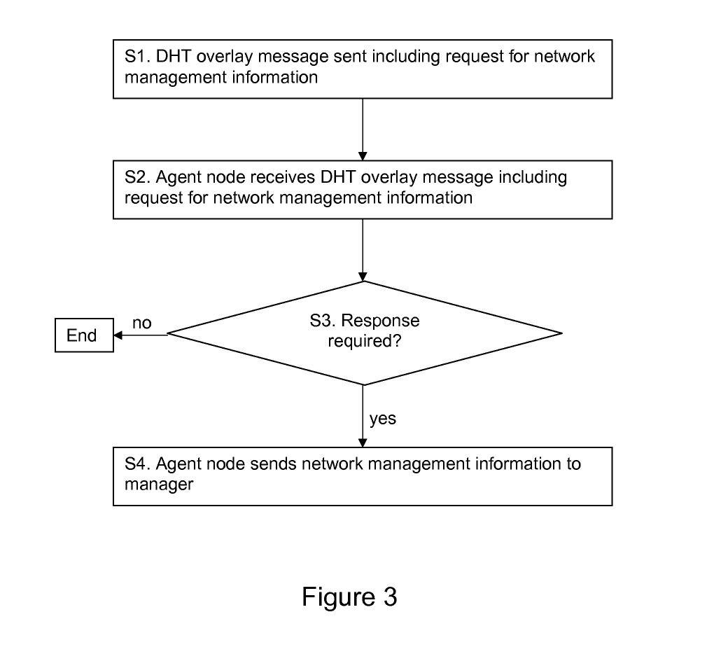

FIG. 3 is a flow diagram illustrating an exemplary process. The following numbering corresponds to that of FIG. 3:

S1. A DHT overlay stabilization message is sent. The DHT overlay stabilization message includes a request for network management information, for example sent using SNMP. The DHT overlay stabilization message may be sent by the manager node 1 itself, or the manager node may delegate the sending of the overlay stabilization message to another peer in the distributed network. Alternatively, logic in any node in the distributed network may trigger the sending of the overlay stabilization message if certain conditions are met. Examples of such conditions include a lot of churn in the overlay, or when a routing table becomes larger than a predetermined size.
S2. The agent node 2 receives the DHT overlay stabilization message and, in addition to handling the overlay stabilization message, handles the network management information.
S3. A determination is made as to whether the agent node needs to respond to the network management message. For example, the network management information may specify that only certain agents need respond to the message, in which case the agent node 2 may not respond. Alternatively, no change may have occurred to the network management information at the agent node 2 since a last update was sent, in which case the agent node 2 need not respond.
S4. If a response is required, the agent node 1 sends a response to the manager node 1.

Examples of piggybacked information include an indication of whether a device is active or not and whether it is a manager or not. An exemplary Overlay stabilization message is sent using the Chord DHT algorithm. This has a recommended periodic update at least every 360 seconds. A peer node that is also a manager node 1 is provisioned with variables to enable this of mechanism:

When sending the getbulkRequest (or other type of request message, such as a getrequest message or a setrequest message), the manager node must inform other nodes in the distributed network that it is a full peer node, and that it has management authorization. The request message may provide a list of nodes from which an update is required, and may adjust the non-repeaters and max-repetitions fields.

In addition to other configuration parameters and variables relating to the network management protocol, the device may also take into account the size of the successor and finger tables, as is currently done with Chord's static configuration.

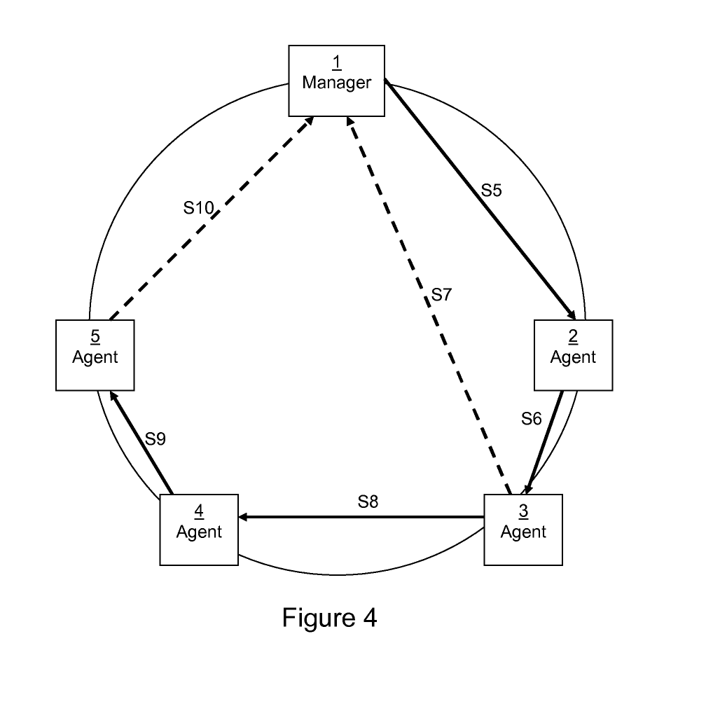

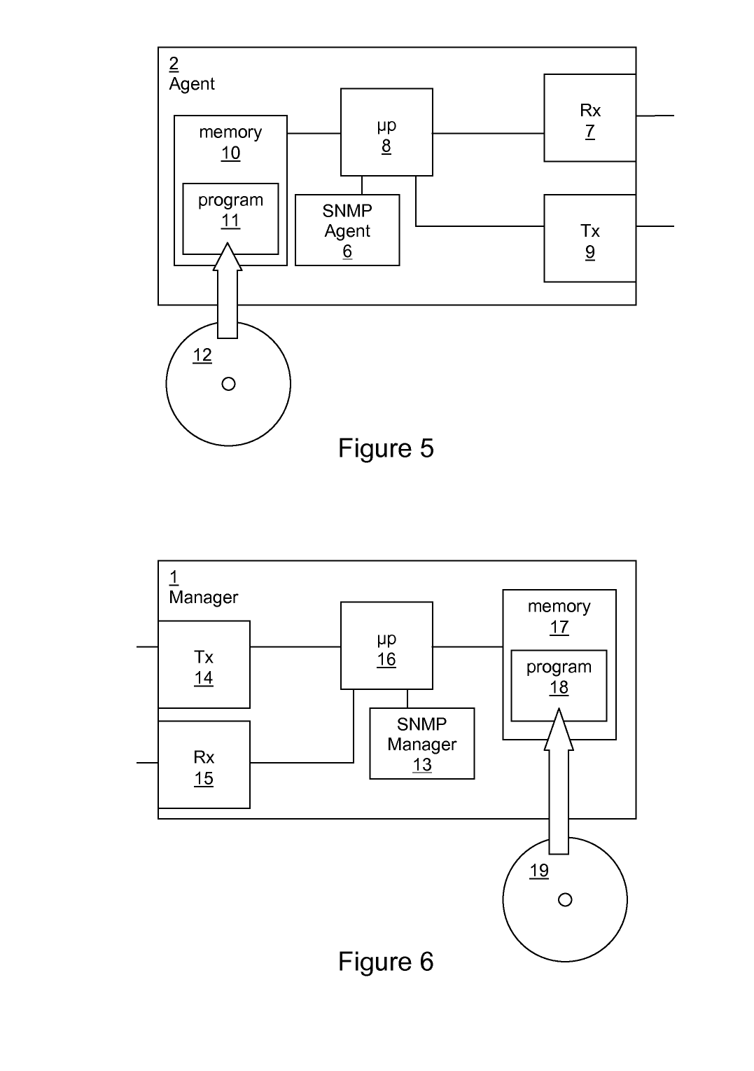

Turning to FIG. 4, there is illustrated an exemplary DHT overlay stabilization message sequence in which an SNMP getbulkRequest message is piggybacked onto the DHT overlay stabilization message. The following numbering corresponds to that of FIG. 5.

S5. The manager node 1 sends a DHT overlay stabilization message towards agent node 2. The message includes an SNMP getbulkRequest message. Agent node 2 determines that it is not identified in the SNMP request, and so does not respond to the manager node 1.
S6. The DHT overlay stabilization message is sent from agent node 2 to agent node 3, which determines that a response is required to the SNMP getbulkRequest message.
S7. Agent node 3 sends an SNMP response to the manager node.
S8. The DHT overlay stabilization message is sent from agent node 3 to agent node 4, which determines that a response is required to SNMP getbulkRequest, but also determines that the requested information has not changed since agent node 4 last responded. It therefore does not send a response to the manager node 1.
S9. The DHT overlay stabilization message is sent from agent node 4 to agent node 5, which determines that a response is required to the SNMP getbulkRequest message.
S10. Agent node 5 sends an SNMP response to the manager node.

It can be seen from a comparison of FIGS. 3 and 4 that using the piggybacking technique described above, the manager node 1 need only send one message, greatly reducing the signalling required.

The technique can be modified by taking advantage of the underlying mechanisms of the overlay.

In a first exemplary technique, the manager node 1 sends a message around the overlay. When the message is received by a peer acting as an agent 2, it triggers a reply to the manager with the requested information. The peer also forwards the message to the next peer acting as an agent 3. This is the scenario illustrated in FIG. 5. There is still be a lot of messaging towards the manager node 1 but it is still be half of it was required before (since the manager node 1 sends only one message). On a destinationlist, the manager node 1 sets a list of target peer nodes, each of the peers on the list would have to reply with the status.

In a second exemplary technique, the manager node 1 does not send anything. The overlay is configured to update the generic information periodically, at the same time that periodic stabilization is being performed, and send the Delta information (modifications on the status) to the manager node 1 automatically. When a peer node sends a message to its successor to check its routing table, it also includes this generic information (interface activity, status, etc.). If something has changed, the peer node sends an update to the manager node 1, and otherwise it does not send anything. In this example, the manager is passive and receives updated information from peer nodes in the distributed network.

In a third exemplary technique, the manager node 1 sends a message with a very large maximum PDU size for the periodic update. Each peer node on the destination list appends its information to the message and forwards it to the next peer in the destination list. If, when appending, the maximum PDU size is reached, the peer node sends the update as it is to the manager node 1, removes the information already in the list, appends its own information and forwards the message to the next peer node in the list. In this way, the manager node 1, instead of receiving thousands of replies, will receive very few (and very large) messages with all the required status information.

FIG. 5 herein illustrates schematically in a block diagram an exemplary agent node 2. The agent node 2 is provided with a network management protocol agent 6, such as an SNMP agent. A receiver 7 is provided for receiving the DHT overlay stabilization procedure message. As described above, the overlay stabilization procedure message includes an instruction for the agent node 2 to send network management information to the manager node 1. A processor 8 is provided for generating a response message, the response message including the required network management information. A transmitter 9 is also provided for sending the response message to the manager node. Note that the network management protocol agent 6 is typically a software agent running on the processor 8.

A computer readable medium in the form of a memory 10 is also provided. This may be used to store data such as network management information. It may also be used to store a computer program 11 which, when executed by the processor 8, causes the processor 8 to behave as described above.

The program 11 may additionally or alternatively be stored on an external memory 12 such as a flash drive or a Compact Disk, from which it can be transferred into the memory 10 or directly into the processor 8.

FIG. 6 herein illustrates schematically in a block diagram an exemplary manager node 1. The manager node 1 is provided with a network management manager 13, such as an SNMP manager. A transmitter 14 is provided for a DHT overlay stabilization message towards an agent node 2, the overlay stabilization procedure message including an instruction for the agent node 2 to send network management information to a manager node 1. A receiver 15 is also provided for receiving network management information from the agent node 2. The network management manager 13 is typically provided as software running on a processor 16.

A computer readable medium in the form of a memory 17 is also provided. This may be used to store data such as network management information. It may also be used to store a computer program 18 which, when executed by the processor 16, causes the processor 16 to behave as described above.

The program 18 may additionally or alternatively be stored on an external memory 19 such as a flash drive or a Compact Disk, from which it can be transferred into the memory 17 or directly into the processor 16.

Network management protocols such as SNMP can be optimized by piggybacking the signalling onto P2P features such as DHT overlay stabilization messages. In P2P networks such as M2M networks, continuous monitoring is fundamental. In order to scale network management protocols such as SNMP, it is very useful to re-use features that already help P2P systems to scale.

SNMP is in use on ISPs for management of their network, but the scale expected from M2M networks will greatly surpass in number of devices that of the largest ISP. Instead of increasing the resources of existing SNMP servers to account for large distributed networks, it is much more efficient to delegate some of the SNMP (or other network management protocol) operations to the underlying DHT overlay stabilization signalling. This simplifies management operations in distributed M2M networks.

It will be appreciated by a person of skill in the art that various modifications may be made to the above described embodiment without departing from the scope of the present disclosure. Different embodiments have been described above, but the skilled person will readily be able to adapt the teachings to other types of network management protocol.

The following abbreviations have been used in the above description:
DHT Distributed Hash Table
M2M machine to machine
MIB Management Information Base
NMS Network Management System
OMADM Open Mobile Alliance Device Management
P2P Peer to peer
PDU Protocol Data Unit
SNMP Simple Network Management Protocol

1. A method of providing network management information to a manager node in a distributed communication network, the method comprising:
receiving at an agent node, a Distributed Hash Table, (DHT) overlay stabilization procedure message, the overlay stabilization procedure message including an instruction for the agent node to send network management information to the manager node; and sending the network management information to the manager node.

2. The method according to claim 1 wherein the network management information is sent using at least one of Simple Network Management Protocol (SNMP) and Open Mobile Alliance Device Management (OMADM) protocol.

3. The method according to claim 1, wherein the instruction comprises at least one of a get bulk request message, a get request message and a set request message.

4. The method according to claim 1, wherein the overlay stabilization procedure message is sent periodically or in the event that an update is required owing to a change in network conditions.

5. The method according to claim 1, wherein the instruction further includes at least one of:
an indication that the manager node is authorized as the manager node;
an identity of at least one node from which the network management information is required; and
adjustments to at least one of non-repeater and maximum repetition fields.

6. The method according to claim 1, further comprising:
determining if the network management information has previously been sent to the manager node and, if so, determining if changes to the network management information have occurred and, if so, sending the network management information to the manager node.

7. The method according to claim 1, further comprising:
determining if the network management information has been requested from the agent node and, if so, sending the network management information to the manager node.

8. An agent node for use in a distributed communication network, the agent node comprising:
a network management protocol agent;
a receiver for receiving a Distributed Hash Table (DHT) overlay stabilization procedure message, the overlay stabilization procedure message including an instruction for the agent node to send network management information to a manager node;
a processor for generating a response message, the response message including the network management information; and
a transmitter for sending the response message to the manager node.

9. The agent node according to claim 8, wherein the processor is arranged to determine a presence, in the DHT overlay stabilization procedure message, at least one of:
an indication that the manager node is authorized as the manager node;
an identity of at least one node from which the network management information is required; and
adjustments to at least one of non-repeater and maximum repetition fields.

10. The agent node according to claim 8, wherein the processor is arranged to determine if the network management information has previously been sent to the manager node and, if so, determine if changes to the network management information have occurred.

11. The agent node according to claim 8, wherein the processor is arranged to determine if the network management information has been requested from the agent node.

12. A manager node for use in a distributed communication network, the manager node comprising:
a network management manager;
a transmitter for sending towards an agent node a Distributed Hash Table (DHT) overlay stabilization procedure message, the overlay stabilization procedure message including an instruction for the agent node to send network management information to the manager node; and
a receiver for receiving the network management information from the agent node.

13. A non-transitory computer readable storage medium containing instructions, which when executed by a processor operating on an agent node in a distributed communication network, causes the agent node to perform operations comprising:
receiving a Distributed Hash Table (DHT) overlay stabilization procedure message, the overlay stabilization procedure message including an instruction for the agent node to send network management information to a manager node; and
sending the network management information to the manager node.

14. A non-transitory computer readable storage medium containing instructions, which when executed by a processor operating on a manager node in a distributed communication network, causes the manager node to perform operations comprising:
sending towards an agent node a Distributed Hash Table (DHT) overlay stabilization procedure message, the overlay stabilization procedure message including an instruction for the agent node to send network management information to the manager node; and
receiving the network management information from the agent node.

15. (canceled)

16. The non-transitory computer readable storage medium according to claim 13 wherein the instructions cause the network management information to be sent using at least one of Simple Network Management Protocol (SNMP) and Open Mobile Alliance Device Management (OMADM) protocol.

17. The non-transitory computer readable storage medium according to claim 13, wherein the instructions cause the agent node to receive the instruction for the agent node that comprises at least one of a get bulk request message, a get request message and a set request message.

18. The non-transitory computer readable storage medium according to claim 13, wherein the instructions cause the receiving of the overlay stabilization procedure message that is sent periodically or in the event that an update is required owing to a change in network conditions.

19. The non-transitory computer readable storage medium according to claim 13, wherein the instructions cause the agent node to receive the instruction for the agent node that further includes at least one of:
an indication that the manager node is authorized as the manager node;
an identity of at least one node from which the network management information is required; and
adjustments to at least one of non-repeater and maximum repetition fields.

20. The non-transitory computer readable storage medium according to claim 13, wherein the instructions further cause the agent node to perform operations comprising:
determining if the network management information has previously been sent to the manager node and, if so, determining if changes to the network management information have occurred and, if so, sending the network management information to the manager node.

21. The non-transitory computer readable storage medium according to claim 13, wherein the instructions further cause the agent node to perform operations comprising:
determining if the network management information has been requested from the agent node and, if so, sending the network management information to the manager node.
